(19) United States
(12) Patent Application Publication
(10) Pub. No.: US 2013/0114572 A1
(43) Pub. Date: May 9, 2013

(54) UPLINK SYNCHRONIZATION WITH MULTIPLE TIMING ADVANCES IN A WIRELESS COMMUNICATION ENVIRONMENT

(71) Applicants: Mo-Han Fong, Sunnyvale, CA (US); Hong He, Beijing (CN); Jong-Kae Fwu, Sunnyvale, CA (US)

(72) Inventors: Mo-Han Fong, Sunnyvale, CA (US); Hong He, Beijing (CN); Jong-Kae Fwu, Sunnyvale, CA (US)

(21) Appl. No.: 13/538,799

(22) Filed: Jun. 29, 2012

Related U.S. Application Data
(60) Provisional application No. 61/556,109, filed on Nov. 4, 2011.

(51) Int. Cl. H04W 56/00; H04W 72/04

(52) U.S. Cl. 370/336; 370/329

(57) ABSTRACT

Technology for synchronization of uplink transmission with multiple timing advances in a wireless communication environment is disclosed. Additional resource allocation messages for additional timing advances are addressed to a user equipment specific search space. A number of band decodes needed to find a resource allocation message used to access an additional timing advance can be reduced by padding the resource allocation message. A number of blind decodes used to find the resource allocation message can also be reduced by restricting the control channel candidates in which the resource avocation can be embedded in terms of the control channel element aggregation level, or levels, associated with acceptable control channel candidates.

### RELATED APPLICATIONS

This application claims the benefit of and hereby incorporates by reference U.S. Provisional Patent Application Ser. No. 61/556,109, filed Nov. 4, 2011, with a docket number P41399Z.

### BACKGROUND

In a cellular wireless communication environment, successful uplink transmission from a wireless communication device/user equipment (UE) to a base station, such as an evolved Node B (eNodeB), involves synchronization of the UE with the eNodeB. Synchronization for uplink transmission typically uses information about the propagation distance between the UE and the eNodeB, which can be included in synchronization information. By using such synchronization information, a UE can synchronize the uplink channel to successfully transmit to the eNodeB.

The eNodeB can determine a propagation distance necessary for this synchronization information by analyzing information, such as a preamble, transmitted from the UE to the eNodeB. The eNodeB can then provide the synchronization information, such as a Time Advance (TA), to the UE on the downlink channel for transmission from the eNodeB to the UE, where the UE has previously been able to synchronize itself to the downlink transmissions of the eNodeB by means of synchronization signals in the downlink transmissions of the eNodeB.

Once the eNodeB transmits the synchronization information to the UE in a physical resource (defined in terms of time and frequency) allocated within the downlink transmission, the UE needs to locate this synchronization information. However, once the synchronization information is found, the synchronization information provided to the UE is only valid for the specific eNodeB transmitting the information to the UE. Furthermore, to speed up the overall synchronization process and to save power and other resources, it is important to find ways to speed up the finding of this synchronization information. When synchronization information is only required for a single eNodeB, the time required to find the corresponding synchronization information can be improved by placing a prior limitations on the physical resources which can carry the synchronization information, thereby reducing the physical resources that need to be searched.

This approach to finding synchronization information, however, is complicated by technologies developed to support ever increasing loads placed on wireless networks. Two such technologies include carrier aggregation and heterogeneous networks. Carrier aggregation combines multiple component carriers (CCs), or swaths of available bandwidth, to increase overall bandwidth, while allowing for multiple uplink and downlink channels on the various CCs associated with the UE. In heterogeneous networks, a single UE can receive transmissions from and transmit to multiple eNodeBs that can have overlapping coverage areas.

In such environments, the propagation distances for uplink transmission on the various CCs can vary depending on which eNodeB, or transmission point, a given CC is associated with. Previous wireless standards, such as Releases 10 of The Third Generation Partnership Project (3GPP) Long Term Evolution (LTE) specification, have addressed this problem by restricting the aggregation of CCs for a UE to CCs that share substantially identical synchronization information. To handle increasing loads, however, it will become necessary to allow CCs associated with multiple eNodeBs/transmission points to be aggregated for a single UE, resulting in the need for UEs to find different units of synchronization information for the different multiple eNodeBs/transmission points.

However, the same restrictions placed on the physical resources for a single unit of synchronization information can be highly problematic when it comes to accommodating the multiple units of synchronization information that will need to be provided in the future. Therefore, new approaches for accommodating these additional units of synchronization information are necessary. Such approaches need to allow additional units of synchronization information to be found quickly and efficiently in terms of power and other resources.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1a is a block diagram illustrating multiple contiguous component carriers in accordance with an example;

FIG. 1b is a block diagram illustrating multiple non-contiguous component carriers and the potential for component carries to reside in different frequency bands in accordance with an example;

FIG. 2a is a block diagram illustrating a wireless communication environment in which a single Timing Advance (TA) may be needed to support multiple component carriers;

FIG. 2b is a block diagram illustrating a wireless communication environment in which multiple TAs are need to support multiple component carriers;

FIG. 3 is a flowchart illustrating the use of a Random Access Control CHannel (RACH) to acquire a TA at a User Equipment (UE);

FIG. 4 is a block diagram illustrating a UE Search Space (USS) in which a resource allocation message may be addressed in accordance with an example;

FIG. 5a is a block diagram of a control region and a Physical Downlink Shared CHannel (PDSCH) of a single sub-frame of a component carrier, illustrating a control region with information about a resource allocation for synchronization information in the PDSCH;

FIG. 5b is a block diagram of a control region for a PDSCH for multiple different sub-frames corresponding to multiple different component carriers, illustrating a resource allocation message in a control region for a first component carrier with information about a resource allocation for synchronization information in the PDSCH of a second component carrier;

FIG. 6 is a block diagram illustrating the padding of a resource allocation message to align a Cyclic Redundancy Check (CRC) with that of another message format for control channel candidates to reduce a potential number of blind decodes to be performed on control channel candidates to find the resource allocation message;

FIG. 7 is a flowchart illustrating a process for restricting the padding of a resource allocation message to situations in which it is helpful, consistent with one example;

FIG. 8 is a block diagram illustrating the relationship between Control Channel Elements (CCEs), aggregation level, control channel candidates, and message formats for control channel candidates;

FIG. 9 is a block diagram illustrating the restriction of a resource allocation message to control channel candidates with a certain aggregation level to reduce the search space for the resource allocation message and the potential number of blind decodes that have to be performed to find the resource allocation message;

FIG. 10 is a flowchart for a generalized process, at an evolved Node B (eNodeB), for detecting uplink control information in accordance with an example;

FIG. 11 is a flowchart for a generalized process, at a UE, for detecting uplink control information in accordance with an example;

FIG. 12 illustrates a block diagram of modules residing at a device used to implement a process for detecting uplink control information in accordance with an example; and

FIG. 13 illustrates a block diagram of a UE in accordance with an example.

Reference will now be made to the exemplary embodiments illustrated, and specific language will be used herein to describe the same. It will nevertheless be understood that no limitation of the scope of the invention is thereby intended.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

### DEFINITIONS

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

### EXAMPLE EMBODIMENTS

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter. The following definitions are provided for clarity of the overview and embodiments described below.

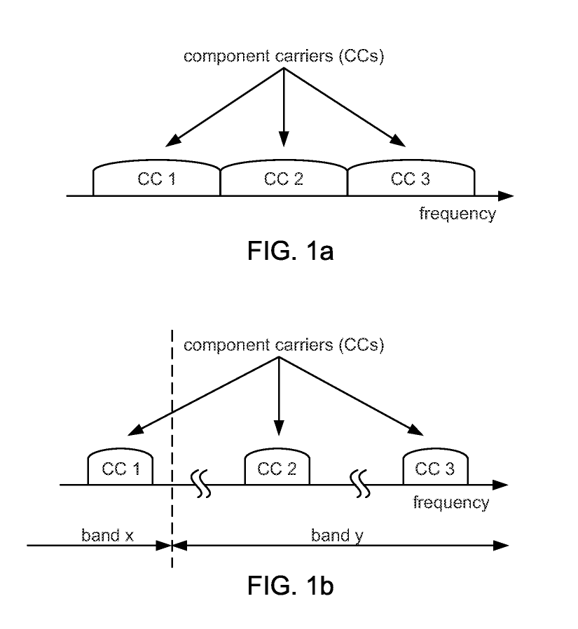

In a wireless communication environment, a wireless device, such as a User Equipment (UE), can be configured to communicate with a base station or transmission point. The base station/transmission point may be, but need not necessarily be, an evolved Node B (eNodeB). The UE can initiate communication with the base station, or eNodeB, via a selected Component Carrier (CC), such as those depicted below in FIG. 1a and FIG. 1b.

While the terminology of the 3GPP LTE standard is used throughout this specification, it is not intended to be limiting. A UE configured to communicate with an eNodeB is considered to be synonymous with a generic radio frequency mobile communication device configured to communicate with a base station/transmission point, unless otherwise noted. Similar comments can be made with respect to CCs and other terms used herein.

FIG. 1a illustrates an example of carrier aggregation, aggregating multiple CCs. A CC defines a range of frequencies over which data can be communicated over the air in relative to a UE for which the CC is activated. By aggregating component carriers, the bandwidth of each component carrier can be combined to increase the overall total available bandwidth. As total available bandwidth increases, larger data loads can be accommodated, speeds maintained or increased, and Quality of Service (QoS) maintained or improved. Carrier aggregation, however, also has important implications for the synchronization of uplink transmission because of the potential for different uplink transmissions on different CCs associated with a single UE.

In the example depicted in FIG. 1a, three CCs are contiguously located along a frequency band. Each carrier is used to communicate data over the air. In a continuous type of carrier aggregation system, the CCs are located adjacent to one another and are typically located within a single frequency band. A frequency band is comprised of a range of frequencies in the radio spectrum region of the electromagnetic spectrum with similar propagation properties, such as path loss and multipath characteristics.

However, it is often not possible to find adjacent swaths of bandwidth available for dedication as additional component carriers from continuous portions of the radio frequency spectrum. Existing spectrum avocation policies and the relatively narrow frequency bands that are currently available for wireless telephony make it difficult to allocate continuous portions of the radio frequency spectrum to achieve large bandwidths, especially as more and more component carriers are required to meet increasing demands placed on wireless communication systems. Therefore, carrier components can be aggregated from non-contiguous portions of the frequency spectrum.

FIG. 1b illustrates an example of carrier aggregation of non-contiguous CCs. The non-contiguous CCs may be separated along the frequency range. CCs may even be located in different frequency bands. For example, and without limitation, CC 1 may be in band x while CC 2 and CC 3 may be in band y, as depicted in FIG. 1b. Since these CCs are in different bands, the propagation characteristics of these CCs may vary widely, resulting in different multi-path characteristics and path loss values. Different multi-path characteristics may even result in different considerations for the synchronization of uplink transmission of different CCs.

The CC on which the UE first initiates communication with the eNodeB, can be designated as a first CC. One or more CCs can appear as a serving cell at the UE in as much as such CCs are capable of both transmitting uplink communications and receiving downlink communications. (However, one or more CCs may also be only be configured for either uplink or downlink communications.) A serving cell associated with the component carrier that is configured for constant communication over control channels/signals between the eNodeB and the UE can also be referred to as a Primary Serving Cell (PCell).

The PCell typically involves the first component carrier setup for a UE. However, any component carrier can be designated as the PCell. If additional CCs are needed at the UE to provide a desired bandwidth, QoS, or other desired features, additional CCs can be assigned to the UE by the eNodeB via Radio Resource Control (RRC) signaling. Additional CCs can be configured and associated with a Secondary Serving Cell (SCell) at the UE. In one embodiment, an SCell can have no physical uplink control channel (PUCCH) transmission to the UE based on the current 3GPP LTE Rel-819/10 specifications. The PUCCH may be transmitted on the PCell. However, an SCeII can be configured to carry the PUCCH in selected environments, such as when the PCell has a low power or significant interference.

The additional CCs may be from contiguous and/or non-contiguous portions of the electromagnetic spectrum relative to the first selected CC of the PCell and may be in the same and/or different frequency bands. They may also be associated with different transmission points or eNodeBs. The different propagation distances between a UE and different eNodeBs can result in different propagation distances, requiring the communication of different units of synchronization information for the different eNodeBs, where a unit of synchronization information provides information necessary to synchronize uplink transmission over a CC to an eNodeB. One or more additional units of synchronization information may also be required for CCs with center frequencies at different portions of the radio spectrum, particularly CCs with center frequencies in different frequency bands.

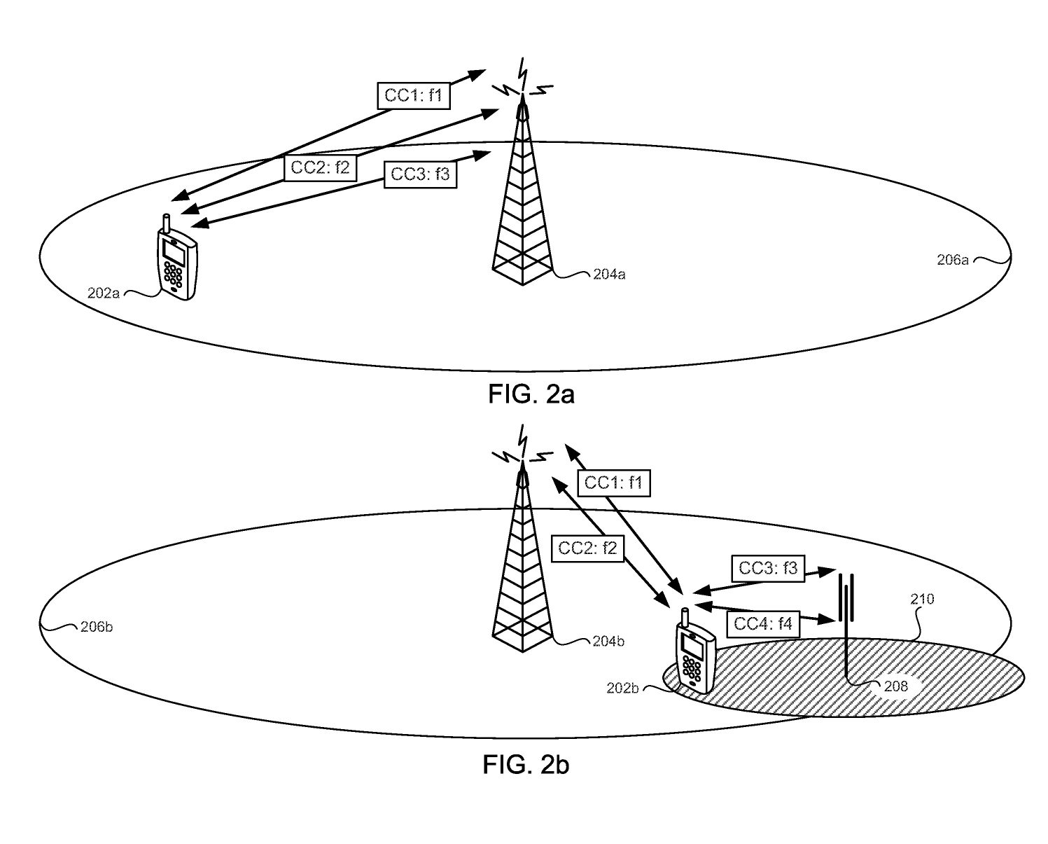

FIG. 2a provides a schematic depiction of a wireless communication environment that supports the aggregation of multiple CCs in which a single unit of synchronization information may or may not be sufficient. In FIG. 2a, a UE 202a communicating with an eNodeB 204a within a geographic region 206a covered by the eNodeB. The eNodeB is configured to communicate with the eNodeB over one of three CCs (CC1, CC2, CC3), which are configured for both uplink and downlink transmissions, although a CC need not always be configured for both uplink and downlink transmission and fewer or more CCs may be employed. The various CCs have different center frequencies, namely, f1, f2, and f3, respectively for CC1, CC2, and CC3.

As can be appreciated, the propagation distance from the UE 202a to the eNodeB 204a is substantially similar for CC1, CC2, and CC3. Generally, therefore, a single unit of synchronization information can be used to synchronize uplink transmissions on CC1, CC2, and CC3. However, in embodiments where a center frequency (f1, f2, and f3) of one or more CCs are sufficiently different from one or more other center frequencies, it can result in propagation differences between the signals. Different frequencies in the electromagnetic spectrum can interact in unique ways with the environment. For example, different frequencies can have higher or lower absorption with atmospheric gasses, such as oxygen. The energy of higher frequency electromagnetic radio waves tend to be more readily absorbed by the atmosphere. In addition, the different frequencies can interact in different ways with solid surfaces, such as buildings, roads, ground, cars, and other infrastructure, with respect to the radio spectrum to produce significantly different multi-path delays, one or more additional units of synchronization information may be necessary, as covered by certain embodiments. Different

FIG. 2b, conversely, provides a schematic depiction of a wireless communication environment that supports the aggregation of multiple CCs from multiple eNodeBs, requiring multiple units of synchronization information to synchronize uplink transmissions on the various CCs. As with FIG. 2a, FIG. 2b depicts a UE 202b communicating with an eNodeB 204b, which can be a macro node, within a geographic region 206b covered by this first eNodeB. In some embodiments, the first eNodeB may be a Low Power Node (LPN), with a smaller geographic coverage than the macro node. In addition to the first node, FIG. 2b also depicts an additional eNodeB 208 with its own transmission region 210.

Together, the first eNodeB 204b and the additional eNodeB 208 can create a heterogeneous network. A heterogeneous network makes more efficient use of available frequency and provides more uniform coverage through the use of additional resources/eNodeBs that are assigned to an area. Although FIG. 2b only depicts two eNodeBs for purpose of explanation, not limitation, many embodiments, as can be appreciated by those of ordinary skill in the art, are consistent with heterogeneous networks with all manner of different additional resources/eNodeBs. The relevance of this point can be appreciated inasmuch as increasing demands placed on wireless networks are resulting in ever increasing numbers of additional resources/eNodeBs being employed to offload and lesson the demand on legacy resources.

The additional eNodeB 208 in FIG. 2b can be an LPN, or, in some embodiments, it can also be a macro node. In embodiments where the additional eNodeB 208 is a LPN, examples of potential LPNs include, without limitation, Remote Radio Heads (RRHs), relays, and small cells, such as micro cells, pica cells, femto cells, and home cells. Whereas, all three CCs (CC1, CC2, and CC3) in FIG. 2a are configured for uplink transmission to a single eNodeB 204a, in FIG. 2b, only two CCs (CC1 and CC2, with center frequencies f1 and f2 respectively) are configured for uplink transmission to the first eNodeB 204b, Two additional CCs (CC3 and CC4, with center frequencies f3 and f4 respectively) are configured for uplink transmission to the additional eNodeB 208.

As can be appreciated, the propagation distance from the UE 202b to the first eNodeB 204b is substantially similar for CC1 and CC2, but varies greatly from the substantially similar propagation distances for CC3 and CC4 from the UE 202b to the additional eNodeB 208. Hence, a different unit of synchronization information may need to be communicated to the UE for CC3 and CC4 than the unit of synchronization information communicated for CC1 and CC2. As before, different numbers of CCs and CC transmission configurations are consistent with various examples and some CCs can require their own unit of synchronization information for reasons of different multi path (due to differing frequencies) even though they may share the same eNodeB.

Although additional units of synchronization information may be used in these examples, the use of a heterogeneous network can result in increased efficiency and an improved uniformity of coverage. Adding these additional units of synchronization can be important to make the use of the additional transmission zone 210 possible. Unfortunately, the current 3GPP LTE Release 10 specification only allows for one unit of synchronization information, referred to as a Timing Advance (TA) (throughout this specification, the term ‘TA’ is encompassed by the term ‘unit of synchronization information’). The single TA can be used for multiple CCs, as in FIG. 2a, to create a Timing Advance Group (TAG). However, accommodation remains to be made for multiple TAs, such as would be required in examples similar to FIG. 2b.

The TA can be used to synchronize uplink transmission by accounting for propagation delay. Propagation delay can be accounted for by adjusting the transmit timing at the UE 202a/b in accordance with a TA. However, the TA is first generated by the eNodeB 204a/b, 208, transmitted to the UE, and discovered at the UE.

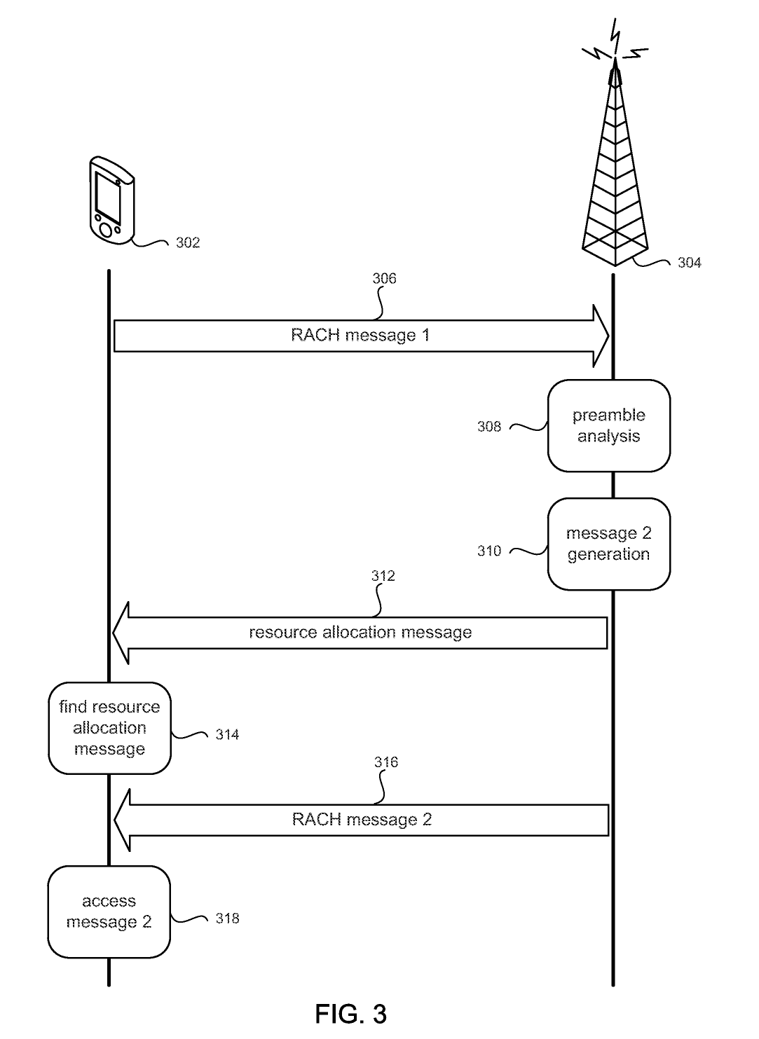

FIG. 3 provides a flowchart for one example of how a TA can be generated and transmitted to a UE 302 through a Random Access Control CHannel (RACH) and discovered by the UE. The 3GPP LTE specification

Releases 8, 9, and 10 designate that a random access preamble is transmitted 306 from the UE to the eNodeB 304 as part of a RACH message 1. The random access preamble can be assigned at the Medium Access Control (MAC) layer in the uplink and communicated on a Random Access Channel (RACH) such as the Physical Random Access Channel (PRACH).

The eNodeB 304 can receive the RACH message 1 and analyze the preamble 308 with a matched filter to correlate the preamble with a timing reference signal, where the correlation indicates how much the transmit timing at the UE 302 needs to be adjusted (forwards or backwards). The eNodeB can then include this information in a TA to be transmitted in the Physical Downlink

Shared CHannel (PDSCH) of a CC to the UE as part of a RACH message 2, or Random Access Response (RAR) generated 310 by the eNodeB. Before the RAR is transmitted in the PDSCH, however, a resource allocation message is transmitted 312 on the Physical Downlink Control CHannel (PDCCH) of a CC.

The resource allocation message, which can be, without limitation, a

Downlink Control Information (DCI) message of format type 1C, or some other type of format or message. The DCI message can provide resource allocation information about the resource(s) allocated in the larger PDSCH, which can be used to carry the RACH message 2. The resource allocation information can be used to enable the UE to locate the RACH message 2 in the PDSCH when it is transmitted 316. The UE 302 can find 314 the resource allocation message so that it can access 318 the RACH message 2, with its TA, when the RACH message 2 is transmitted 316 to the UE, whether this occurs before or after the UE finds the resource allocation message.

Currently, in the 3GPP LTE Release 10 specification, RACH is supported only on the PCell and the TA is based on synchronization to the PCell. No RACH procedure is allowed for an SCell. To accommodate heterogeneous networks, such as a heterogeneous network described in relation to FIG. 2b, additional TA values may be needed. In this example, where CC3 and CC4 can both be configured for uplink and downlink transmission as SCells from an eNodeB in a similar geographic region, the two SCells may be able to use a common TA that is different from a TA for CC1 and CC2. The CC1 and CC2 can also use a common TA value, due to the similar geographic region of their eNodeB. In this example, the CC1 and/or CC2 may be configured as the PCell. An SCell RACH can be configured, in certain, but not all examples, to support cross-carrier scheduling where the POOCH for a resource allocation message for RACH message 2 can be sent on a different CC than the RACH message 1,

The PDCCH can provide control information to multiple UEs in a cell, Individual UEs can search for and decode control information in the POOCH that is intended for that individual UE. Accordingly, the POOCH can be referred to as a search space. When an additional TA value is configured for an SCell, additional DCI can be embedded in the PDCCH search space to identify the location of the message 2 in the PDSCH for the SCell. The UE can locate these additional TAs by first looking for the DCI containing the resource allocation message in the PDCCH search space.

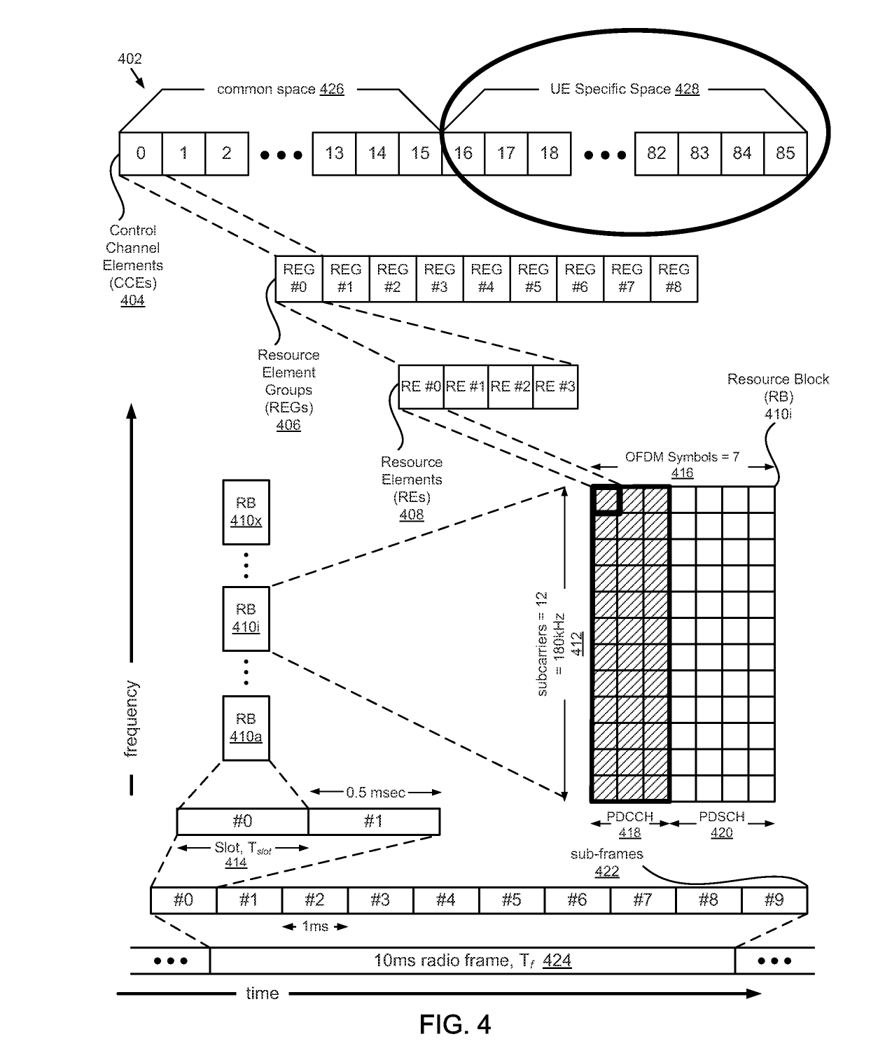

FIG. 4 is a block diagram illustrating a PDCCH search space 402, its various elements and components, and their relationship to various physical resources with an Orthogonal Frequency Division Multiplexing (OFDM) modulation scheme. The PDCCH search space pertains to a particular CC and can be formed with one or more successive Control Channel Elements (CCEs) 404. Several DCI messages (not shown), including the resource allocation message, are assigned at an eNodeB in what can be called control channel candidates (not shown) that are embedded into CCEs in the PDCCH search space. UEs then search for the control channel candidates for DCI messages in the PDCCH search space.

Each CCE used in the PDCCH search space 402 can include 9 Resource Element Groups (REGs) 406. Each REG can include four resource elements (REs) 408. The RE is the smallest physical resource unit in such an OFDM scheme and carries a single modulated symbol, which can carry various numbers of bits worth of information, depending on whether the modulation and coding scheme employs BPSK, QPSK, 16QAM, 64QAM etc.

These REs are transmitted in Resource Blocks (RBs) 410a-410x. As many as 84 resource elements REs can be mapped to a single RB. The various REs in a RB can be mapped to an OFDM grid defined with respect to time and frequency. With respect to frequency, a RB 410i can include twelve subcarriers 412, wherein each subcarrier is configured to be substantially orthogonal to all other subcarriers and each subcarrier can span a range in frequencies of 15 KHz. Each subcarrier can carry a different RE/symbol at any given period of time.

With respect to time, a RB 410i comprises a single slot 414, with a 0.5 millisecond duration. Each slot can hold seven OFDM symbols 416 if a short or normal cyclic prefix is employed, or six OFDM symbols if an extended cyclic prefix is used. RBs are further divided into a PDCCH 418 and a PDSCH 420 with respect to time. The first 1 to 3 columns of REs/OFDM symbols of a RB can belong to the PDCCH (3 columns in FIG. 4). The remaining columns are allocated to the PDSCH. The PDCCH search space 402 is located in the PDCCH.

Many RBs 410a-410x can be deployed adjacent to one another, either contiguously or non-contiguously with respect to frequencies in the radio spectrum. For example, a 1.4 MHz CC can comprise 6 RBs, for a total of 72 subcarriers. As another example, a 20 MHz CC can comprise 100 RBs, for a total of 1200 subcarriers. As stated, with respect to time, a RB comprises a single 0.5 millisecond slot 414. A pair of two slots can make up a 1 millisecond sub-frame. A 10 millisecond frame can include 10 sub-frames 422. Downlink and uplink transmissions can comprise a series of frames 424 being transmitted with respect to time.

Returning to the PDCCH search space 402, the PDCCH search space includes both a common search space (CSS) 426 and a UE specific search space (USS) 428. The CSS can provide scheduling, synchronization, and other control information for a group of UEs in a cell. The USS can provide scheduling, synchronization, and other control information for a particular UE. In one embodiment, the CSS can be composed of the first 16 CCEs (CCE 0 through CCE 15), and the remaining CCEs may to allocated to the USS.

To search for DCI messages in the PDCCH, such as the resource allocation message, a UE can use a Radio Network Temporary Identifier (RNTI) assigned to the UE by the eNode B to try and decode candidates in a process that is called blind decoding. The RNTI can be used to demask a PDCCH candidate's Cyclic Redundancy Check (CRC) that was originally masked by the eNodeB using the UE's RNTI in the CRC.

In one embodiment, to reduce the burden and improve the process performance of a UE, Release 8, 9, and 10 of the 3GPP LTE specifications address the resource allocation message, for the RACH 2 message with the single TA allowed under these releases, by masking its CRC with a random access RNTI (RA-RNTI). The RA-RNTI is used with the CSS 426. By masking the CRC of the resource allocation message with a RA-RNTI, the search space that is blind decoded by the UE is reduced from the entire POOCH search space 402 to just the CSS 426, greatly reducing the number of blind decodes, time, and other resources that need to be devoted to finding the resource allocation message.

As the technologies of carrier aggregation and heterogeneous networks are employed to handle increasing demands placed on wireless networks, additional TAs will need to be communicated to a given UE for CCs having different frequencies, or nodes with different geographic locations, together with the additional resource allocation messages that will be used to access them. These additional resource allocation messages could be transmitted, as before, in the CSS 426 of the PCell, or even the CSS of an SCell where multiple component carriers are configured as serving cells. Unfortunately, the CSS is already very crowded, especially considering that the CSS is shared by all UEs in a cell. Including one or more additional resource allocation messages in the CSS is likely to lead to those messages getting blocked.

These problems can be solved by addressing the one or more additional resource allocation messages in the USS 428. To address the one or more additional resource allocation messages, they cannot be masked with an RA-RNTI. A UE unique identifier is used to mask messages in the USS. For example, a Cell-RNTI (C-RNTI) value may be used as a mask. Therefore, the eNodeB can identify a C-RNTI pertaining to a UE to research a resource allocation message/DCI message which can include resource allocation information for the RACH message 2. The eNode B can then mask the resource allocation message/DCI message with the C-RNTI, which is also provided to the UE. A CRC of a resource allocation message that is masked with the C-RNTI does not produce a CRC error during blind decoding with the C-RNTI. The eNodeB then sends the resource allocation message/DCI message in one or more CCEs in the USS of the PDCCH search space 402. The USS in FIG. 4 is circled to indicate that the USS contains the CCEs in which the allocation message/DCI message can be embedded in embodiments.

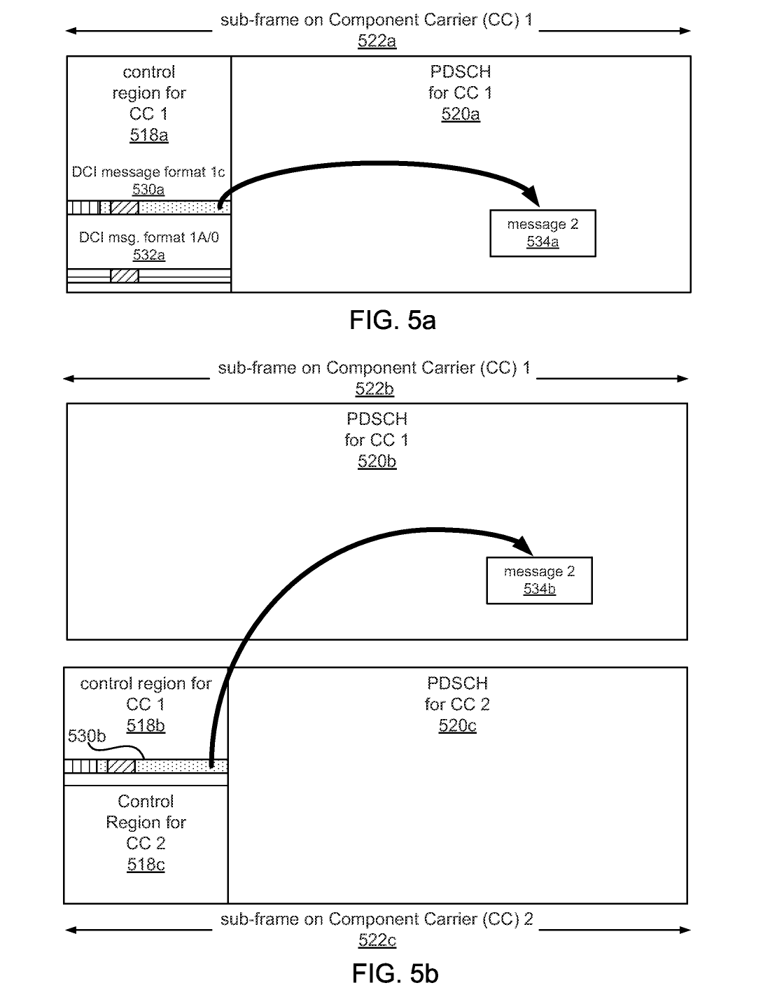

FIG. 5a is a block diagram of a sub-frame on a single CC 522a. The sub-frame is divided into a control region 518a for CC 1 and a PDSCH 520a. The control region can be configured to carry the POOCH search space 402, including the USS 428. The resource allocation message 530a is depicted in the control region as a padded DCI message of format 1c. Other DCI formats and messages are possible. Padding of DCI messages is discussed more fully in the proceeding paragraphs.

An additional DCI format message 532a is also depicted. However, the additional DCI message does not carry resource allocation information and can serve another purpose. The additional DCI message may be of format type 1A or 0. It may also be, without limitation, of DCI format type 1B, 1C, 10, 2, 2A, 3, 3A. Although only a single additional DCI message is depicted, there can be multiple additional DCI messages in the control region. Although the resource allocation message 530a is in the control region, the resource allocation information that it carries indicates which resources are allocated in the PDSCH for the RACH message 2 (534a), which carries the TA, so that it can be accessed when it is transmitted.

FIG. 5b is similar to FIG. 5a, in that the two figures depict a resource allocation message 530a/530b. The two figures differ, however, in several ways, including the multiple sub-frames 522b, 522c for multiple CCs depicted in

FIG. 5b. Additionally, the RACH message 2 (534b) is not in the same sub-frame or CC as the resource allocation message. The second sub-frame 522c includes a first control region 518b for the first sub-frame 522a and PDSCH 520b of CC1 and a second control region 518c for the second sub-frame 522c and PDSCH 520c of CC2. Since the resource allocation message is in the control region 518b for CC 1, even though the resource allocation message is sent on CC2, the resource allocation message can inform the UE about resources allocated for the RACH message 2 on CC1. To acquire this resource allocation, however, the UE must first blind decode the resource allocation message.

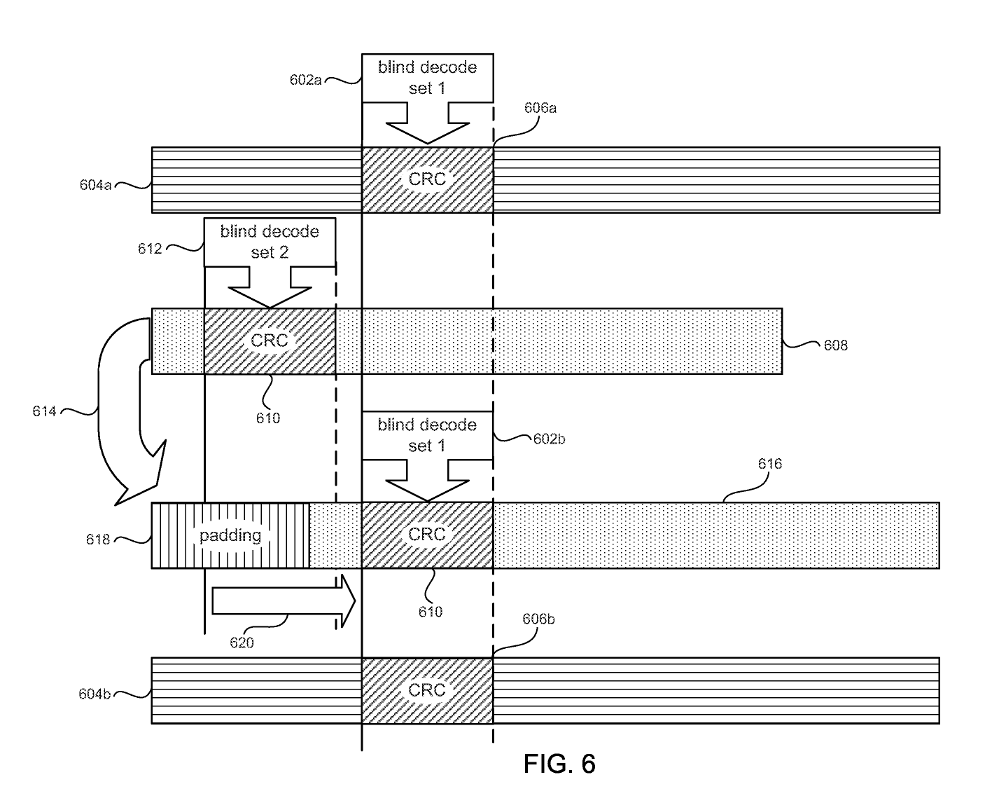

FIG. 6 illustrates important aspects of the blind decode process. In the figure, a first blind decoding operation 602a can be applied to a first DCI message 604a in one control channel candidate (not shown) among the many control channel candidates within a search space. The first blind decode operation can be aligned to be applied to the first CRC 606a of the first DCI message. A blind decode operation can proceed by applying a RNTI, such as an RA-RNTI or a C-RNTI, to demask the region of a control channel candidate for which it has been aligned. If the CRC of the message in the control channel candidate has been masked with the RNTI, there will be no CRC error detected, indicating that the message being searched for has been found.

A second DCI message 608 is also depicted. The second DCI message 608 can be a resource allocation message. However, the second CRC 610 for the second DCI message does not coincide with the alignment of the first band decode operation 602a. Therefore, the RNTI will invariably be applied to a region of a second DCI message that has not been masked with the RNTI, resulting in CRC errors.

To find the resource allocation information, a second blind decode operation 612 can be applied to each control channel candidate in the search space. The second blind decode operation can be aligned to the location of the second CRC 610 for the second DCI message, as determined by the DCI format type of the second DCI message. Unfortunately, since the UE does not know for which control channel candidates it should perform this second blind decode operation in the search space, it must potentially perform an additional blind decode on all of them, resulting in wasted time, power, and other resources.

In Release 8 of the 3GPP LTE specification, the total number of blind decodes is set at 44, 12 for the CSS and 32 for the USS. The 32 blind decodes in the USS correspond to two distinct blind decode operations on 16 different control channel candidates. The two blind decode operations are aligned for the CRC in format type 0 and format type 1A, which have a substantially similar alignment, and a transmission mode dependent type DCI format, typically one or more of DCI format types 1, 1B, 1D, 2, and 2A.

Releases of the 3GPP LTE specification that support Multiple Input Multiple Output (MIMO) raise the total number of potential blind decodes in the USS to 48 because of 16 additional blind decodes necessary to accommodate another blind decode operation aligned to a third DCI format (typically one or more of DCI format types 1D, 2, and 2A) and performed on all 16 control channel candidates. In the CSS, only two blind decode operations are performed on 6 control channel candidates for the total 12 blind decodes performed in the CSS,

Sending the resource allocation message in the USS uses an additional DCI format to carry the resource allocation message. A good candidate, although not necessarily the only candidate is DCI format 1C, a comparatively short DCI message. (Whereas DCI formats 0 and 1A use 42 bits, DCI format 1C uses only 26 bits.) However, since DCI format 1C is shorter than other DCI formats, the CRC of DCI format 1C does not align with other DCI formats. This can mean that an additional blind decode operation, aligned for the CRC of DCI format 1C, will need to be performed, resulting in 16 additional blind decodes. These 16 additional blind decodes would result in a 50% increase where MIMO is not employed and a 34% increase where it is employed. The additional blind decodes can result in a large waste of time, power, and other resources.

In certain embodiments, however, this increase of 16 blind decodes can be eliminated by padding 614 the second DCI message to create a padded second DCI message 616. In such embodiments, the eNodeB can pad the second DCI message with an amount of padding 618 sufficient to make the second DCI message achieve a size that is substantially equal to a standard size corresponding to at least one other predetermined DCI format. In certain embodiments, the standard size can correspond to a size for DCI format 0 and/or DCI format 1A. Additionally, the eNodeB can pad the second DCI message to shift 620 the second CRC 610 of the second DCI message to align it with the first CRC 606a of the first DCI message 604a.

After the second DCI message 608 has been padded 614 to produce the padded second DCI message 616, the second CRC will be aligned for the first blind decode operation 602b. Therefore, as depicted in FIG. 6, a single blind decode operation can be performed on both the padded second DCI message 616 and an analogous DCI message 604b similar to the first DCI message 204a, with an analogous CRC 606b. Therefore, such embodiments can handle TAs in multiple RACH 2s with multiple resource allocation messages addressed to USSs, without increasing a number of potential blind decodes, saving time, power, and other resources.

Although the padding of a resource allocation can result in drastic gains in efficiency, there are times when this additional step may not be desired. For example, in cases where a single TA is used for uplink synchronization by a UE, such as in scenarios consistent with FIG. 2A, the traditional approach of sending the resource allocation message for the single TA in the CCS is sufficient and does not require padding. Therefore, additional efficiencies at the eNodeB can be obtained by determining when additional padding of the resource allocation message is helpful and when it is not.

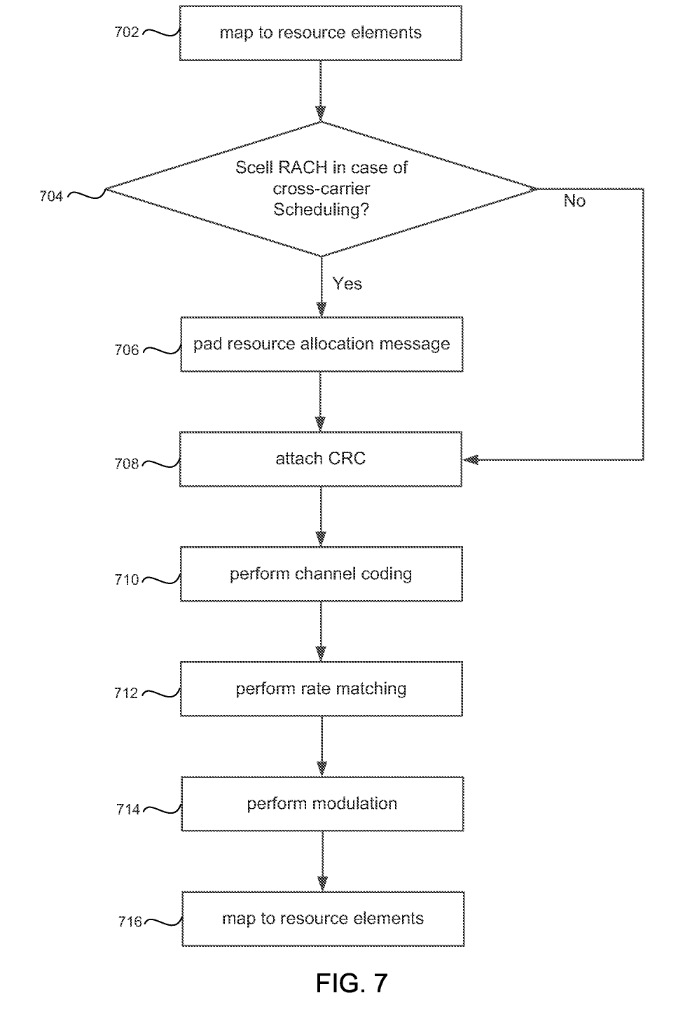

FIG. 7 depicts the generation and processing of a resource allocation message according to one process, consistent with certain examples, that accounts for need for resource allocation message padding. The process begins by generating 702 a resource allocation message with information about the resources in a PDSCH allocated for a RACH message 2 with a TA. The process then determines 704 whether the RACH communication is a SCell RACH.

The first TA associated with a UE can be acquired for a RACH configured for a PCell, as recited in Release 10 of the 3GPP LTE specification. The resource allocation message associated with such a PCell RACH can be transmitted from the eNodeB according to the traditional approach in the CSS, where padding is not necessary. Therefore, in certain embodiments, the transmission of additional TAs for a UE can be relegated to an SCell. In such embodiments, therefore, the preparation of a resource allocation message will be proceeded by an SCell RACH. Therefore, if the determination 704 as to whether the RACH is an SCell RACH is positive, the process continues by padding 706 the resource allocation message, as discussed above with respect to FIG. 6. If the determination is negative, the process continues by processing the resource allocation without padding. Although such embodiments only pad the resource allocation message where the RACH is an SCell RACH, in alternative embodiments, where resource allocation messages for additional TAs are sent on a USS of a PCell, the resource allocation message can still be padded where there is no SCell RACH.

In embodiments consistent with those depicted in FIG. 7, after padding 706 the resource allocation message, or where there is no SCell RACH, the process continues by attaching 708 a CRC to the resource allocation message. This can be accomplished by masking with the C-RNTI identified by the eNodeB for the particular UE destined to receive the resource allocation message. The process continues by performing channel coding 710 and rate matching 712 for the resource allocation message. The performance of modulation 714 is then carried out and the result is mapped 716 to resource elements similar to those described with respect to FIG. 4.

The padding of resource allocation messages can reduce blind decodes consistent with certain embodiments. Additional approaches to reducing blind decodes are also consistent with embodiments. Previously, control channel candidates upon which blind decodes are performed have been introduced in this application. In certain embodiments, additional characteristics of control channel candidates can be leveraged, consistent with these embodiments to reduce blind decodes.

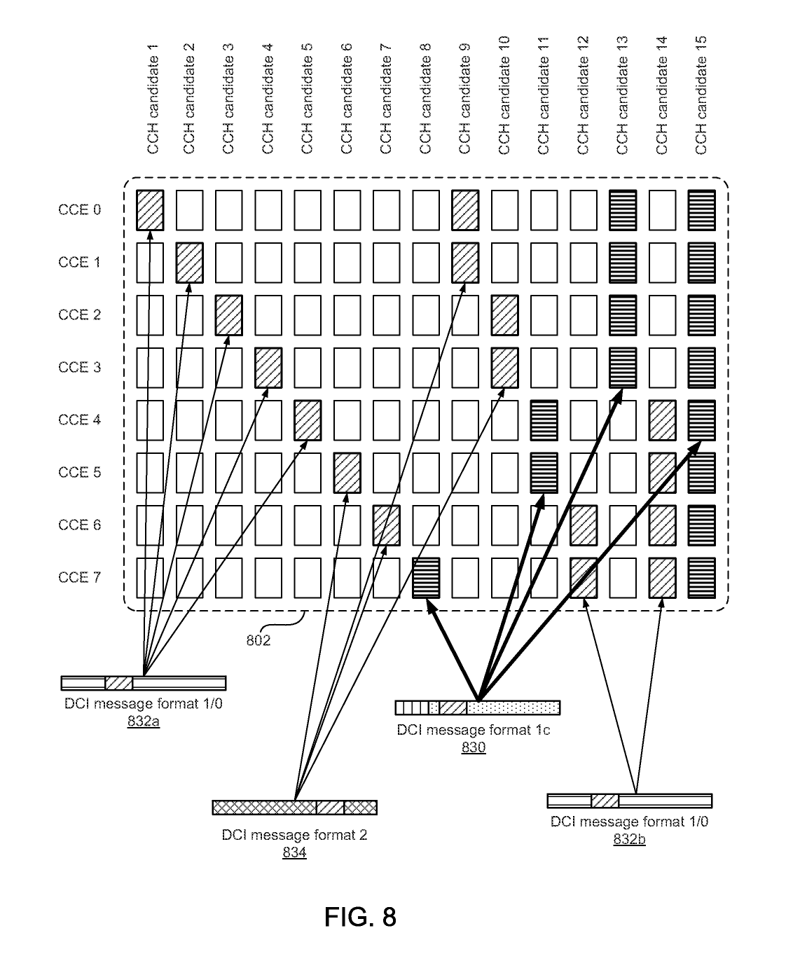

FIG. 8 depicts characteristics of control channel candidates that can be used to reduce blind decodes in terms of the relationships between control channel candidates, CCEs, and aggregation level. In the figure, 15 different control channel candidates, from the traditional 16 control channel candidates of the USS 802, are depicted for purposes of illustration. These 15 control channel elements are mapped to eight different CCEs, similar to those discussed with respect to FIG. 4.

The first eight control channel candidates, CCH candidates 1-8, map to the eight different CCEs. These control channel elements can be said to have a CCE aggregation level of 1 because they are each transmitted in a single CCE. The next four control channel candidates, CCH candidates 9-12, each map to two CCEs. Because these control channel candidates are transmitted in two

CCEs, they can be said to have a CCE aggregation level of 2. The next two control channel candidates, CCH candidates, 13 and 14, can be said to have a CCE aggregation level of 4 because they are each mapped to and transmitted in 4 CCEs. Similarly, control channel candidate 15 can be said to have a CCE aggregation level of 8 because it is mapped to and transmitted in 8 CCEs. A control channel candidate 16 (not shown) also has a CCE aggregation level of 8 and is mapped to and transmitted in an additional 8 CCEs, which are not depicted in this example.

CCEs in the grid defined by CCEs and control channel candidates that are associated with a control channel candidate are filled with either a diagonal or horizontal pattern. Additionally each control channel candidate can, although not necessarily carry, a single DCI message, as indicated by the arrows pointing from the depicted DCI messages 830, 832, and 834. The arrows are included by way of illustration, not limitation, to illustrate that any given message can be embedded in any given control channel candidate. However, a given message may only be in one control channel candidate, or none at all. One of these DCI message can be a resource allocation message 830. (Although the resource allocation message is depicted as a DCI message of format type 1C, other format types and types of messages are possible and can be padded or unpadded, consistent with various different embodiments.)

The arrows pointing from the resource allocation message 830 point to one example of a control channel candidate, whose corresponding CCEs are depicted with horizontal patterns to link them to the resource allocation message, associated with each of CCE aggregation level 1, 2, 4, and 8, indicating that the resource allocation message can potentially be embedded in a control channel candidate with any CCE aggregation level. Although the arrows from the resource allocation message only point to four different control channel candidates, the resource allocation message can be embedded in any control channel candidate. Examples of additional DCI messages of different types of DCI formats, such as DCI messages of format types 0 or 1A (832a, 832b, respectively) and format 2 (834) are also included for purposes of illustration. However, such messages may not be necessary and other message types are also possible.

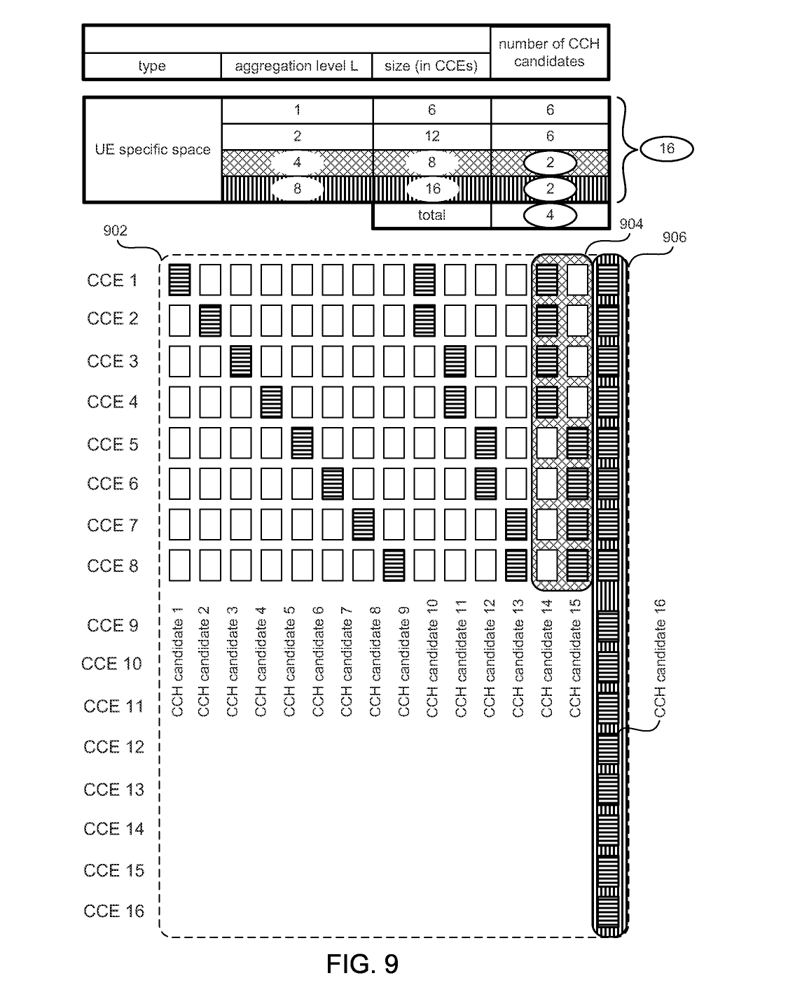

FIG. 9 also depicts a USS 902 by means of a grid defined by control channel candidates and CCEs that carry them. However, in this figure, the full 16 control channel candidates of the USS are depicted in conjunction with the 16 CCEs necessary to create 16 control channel candidates. CCEs corresponding to the various control channel candidates are depicted with horizontal fill pattern. Additionally, a table is depicted showing a number of control channel candidates necessary corresponding to aggregation levels 1, 2, 4, and 8, and the number of CCEs necessary to support these various numbers of control channel candidates at the corresponding aggregation levels for a search space of type USS.

The number of CCEs used to transmit one piece of control information in a control channel, Le., the CCE aggregation level of a control channel candidate, can be determined according to the receiving quality of the POOCH, or other factors. Both the table and the grid 902 utilize a diamond pattern to illustrate embodiments where a predetermined CCE aggregation level of 4 is chosen for the resource allocation message. Similarly, the table and the grid 902 utilize a vertical pattern to illustrate embodiments where a predetermined CCE aggregation level of 8 is chosen for the resource allocation message,

As can be appreciated from both the table and the grid 902, in embodiments where the resource allocation message is only embedded, at the eNodeB, in control channel candidates with a CCE aggregation level of 4, there are only 2 control channel candidates that the UE need decode. Similarly, in embodiments where the resource allocation message is only embedded, at the eNodeB, in control channel candidates with a CCE aggregation level of 8, there are only 2 control channel candidates that the UE need decode. Hence, in embodiments where CCE aggregation levels of 4 or 8 are permissible, there are only 4 control channel candidates that the UE need decode. This is a quarter of the total 16 control channel candidates in the USS of the POOCH that would otherwise need to be decoded.

Accordingly, in one embodiment, the number of decodes can be reduced by limiting the DCI information to being located at selected aggregation levels, such as an aggregation level of 4 our 8. Other types of aggregation level limitations may also be incorporated, based on system design needs, as can be appreciated.

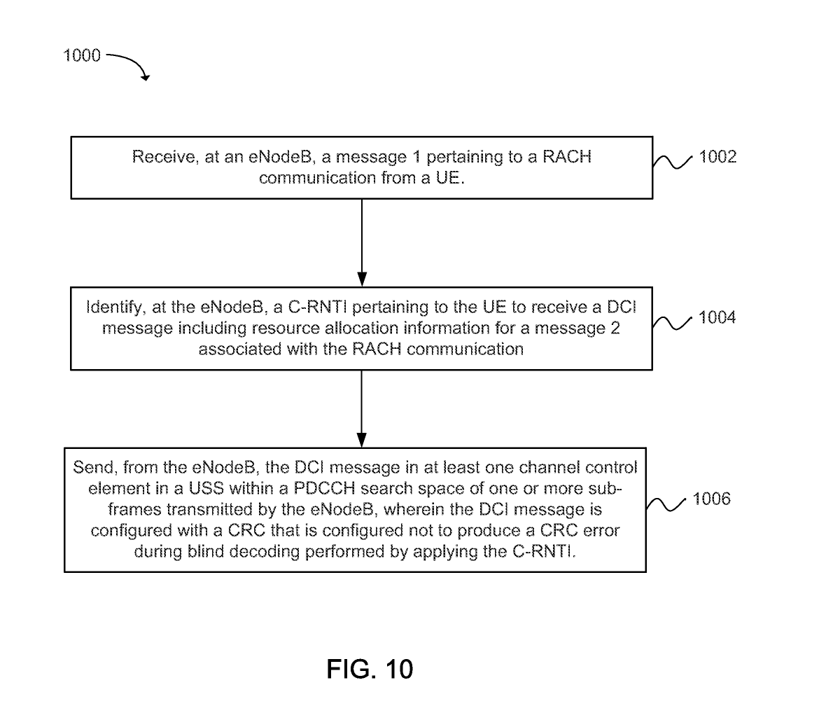

FIG. 10 depicts a method 1000 for detecting uplink control information, at an eNodeB, consistent with an example. The method comprises receiving 1002, at an eNodeB, a message 1 pertaining to a RACH communication from a UE. Additionally, the eNodeB identifies 1004 a C-RNTI pertaining to the UE to receive a DCI message including resource allocation information for a message 2 associated with the RACH communication. Finally, the eNodeB sends 1006 the DCI message in at least one channel control element in a USS within a PDCCH search space of one or more sub-frames transmitted by the eNodeB. The DCI message is configured with a CRC. The CRC is configured not to produce a CRC error during blind decoding performed by applying the C-RNTI to the DCI message.

In certain embodiments, the eNodeB pads the DCI message to achieve a size that is substantially equal to a standard size corresponding to at least one other predetermined DCI format to reduce a number of blind decodes used to detect the DCI message. Among such embodiments, the predetermined DCI format corresponds to a size of DCI format 0 and/or DCI format 1A. Also, certain of such embodiments can first determine that the RACH is a SCell RACH before padding. In some embodiments, the eNodeB detects a RACH communication from a UE. Additionally, in embodiments, the eNodeB can determine a serving cell of the UE with a PDCCH on which to respond to the RACH communication.

In additional embodiments, the eNodeB, the DCI message is carried in a number of CCEs corresponding to at least one predetermined CCE aggregation level to reduce a number of blind decodes used to detect the DCI message. In such embodiments, the set of predefined aggregation levels comprises at least one of a predefined CCE aggregation level of 4, for a PDCCH search space size of 8 CCEs, and a predefined CCE aggregation level of 8, for a PDCCH search space size of 16 CCEs.

In certain embodiments, the message 2 can be sent on a different serving cell than the message 1 of the RACH communication in accordance with cross-carrier scheduling. In additional embodiments, a TAG can be formed for multiple SCells with a TA value that is included in the message 2. The multiple SCells in the TAG can be associated with a particular geographic location. In certain embodiments, the USS within the PDCCH search space is configured for at least one of a PCell and a SCell.

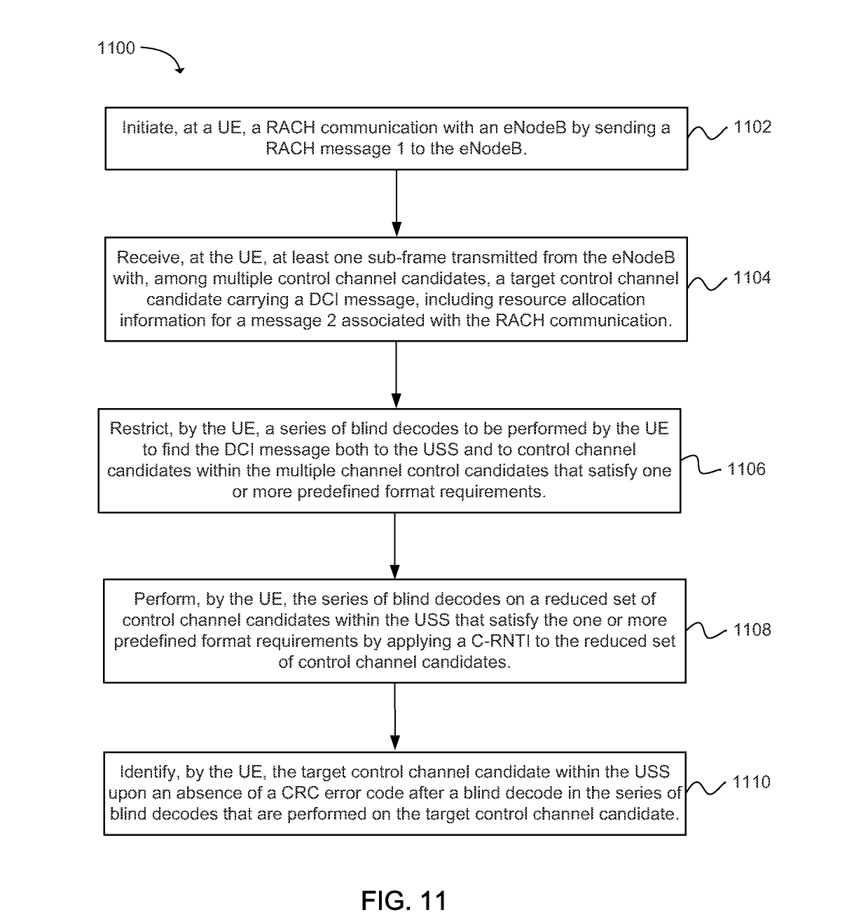

FIG. 11 depicts a method 1100 for detecting uplink control information, at a UE, consistent with an example. The method comprises initiating 1102, by a UE, a RACH communication with an eNodeB by sending a RACH message 1 to the eNodeB. The UE then receives 1104 at least one sub-frame transmitted from the eNodeB with, among multiple control channel candidates, a target control channel candidate carrying a DCI message. The DCI message includes resource allocation information for a message 2 associated with the RACH communication. The multiple channel control candidates reside within a USS within a PDCCH search space in the at least one sub-frame. The multiple channel control candidates are configured with a CRC.

The UE also restricts 1106 a series of blind decodes to be performed by the UE to find the DCI message both to the USS and to control channel candidates within the multiple channel control candidates that satisfy one or more predefined format requirements. The UE further performs 1108 the series of blind decodes on a reduced set of control channel candidates within the USS that satisfy the one or more predefined format requirements by applying a C-RNTI to the reduced set of control channel candidates. Finally, the UE identifies 1110 the target control channel candidate within the USS upon an absence of a CRC error code after a blind decode in the series of blind decodes that are performed on the target control channel candidate.

In some embodiments, the RACH message 1 is sent on a serving cell different from a serving cell on which the DCI message is received at the UE. In certain embodiments, the one or more predefined format requirements comprise a DCI format size corresponding to a standard DCI format size of at least one predetermined DCI format to reduce a number of blind decodes used to detect the DCI message. In additional embodiments, the one or more predefined format requirements comprise at least one CCE aggregation level for a number of CCEs in a given control channel candidate to reduce a number of blind decodes used to detect the DCI message.

Some embodiments further comprising extracting, at the UE, a TA from the message 2. Further embodiments can further comprise forming, at the UE, a TAG for multiple SCells with the TA. Also, in some embodiments the USS within the PDCCH search space is configured for at least one of a PCell and a SCell.

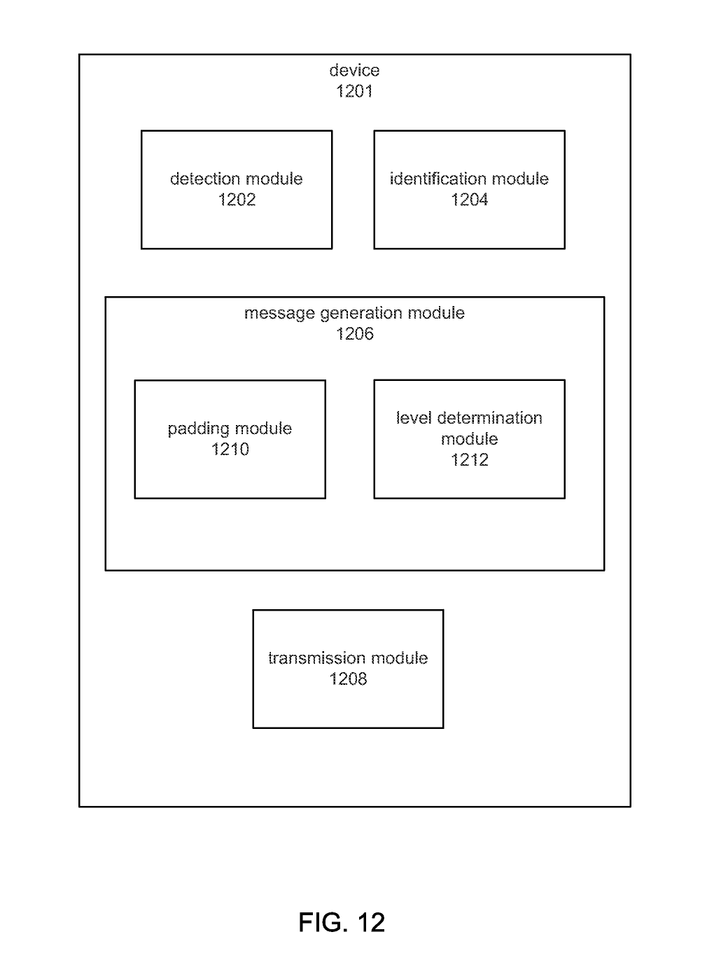

FIG. 12 depicts modules at a device 1201, which in some embodiments can be an eNodeB, base station, or other type of wireless access point, which is used to implement a process for detecting uplink control information in accordance with an example. In one example embodiment, the device can include a detection module 1202 operating at an eNodeB that is configured to detect a message 1 from a RACH communication from a UE. Additionally, the device can include an identification module 1204 operating at the eNodeB that is configured to identify a C-RNTI, upon detection of the message 1 by the detection module. The C-RNTI corresponds to a USS of a serving cell of the

UE with a PDCCH. Additionally, a message generation module 1206 can be included that is configured to embed the C-RNTI in the CRC of a DCI message together with resource allocation information for a message 2 associated with the RACH communication. A transmission module 1208 can also be included that is configured to send the DCI message generated by the message generation module to the UE over the serving cell of the UE that is configured to carry the PDCCH.

In some embodiments, the device can also include a padding module 1210 in communication with the message generation module 1206. The padding module can be configured to pad the DCI message so that a location of the CRC embedded in the DCI message corresponds with a standard CRC location corresponding to at least one other predetermined DCI format to reduce a number of blind decodes used to detect the DCI message containing the information about the location of the message 2. In such embodiments, the CRC location corresponds to a standard CRC location for at least one of DCI format 0 and DCI format 1A. Also, in certain embodiments, the detection module first determines the RACH communication is a SCell RACH communication.

In additional embodiments, the device can include a level determination module 1212 within the message generation module 1206. The level determination module can be configured to determine a number of CCEs in which to embed the DCI message, the number corresponding to a CCE aggregation level. In such embodiments the level determination module can determine to embed the DCI message in a number of CCEs corresponding to a CCE aggregation level at least one of 4 and 8. Furthermore, the level determination module can also, in certain embodiments, determine to embed the DCI message in a number of CCEs based on channel information relevant to the PDCCH. In some embodiments, the message generation module is configured to embed a TA configured to be a basis for a timing advance group (TAG) in the message 2.

A timing advance group is a group of nodes, such as base stations or eNodeBs that are located in a similar geographic region. The similar geographic region can enable each of the eNodeBs to use a same TA value. By forming timing advance groups, it can reduce the number of different TAs that are needed in a heterogeneous wireless network.

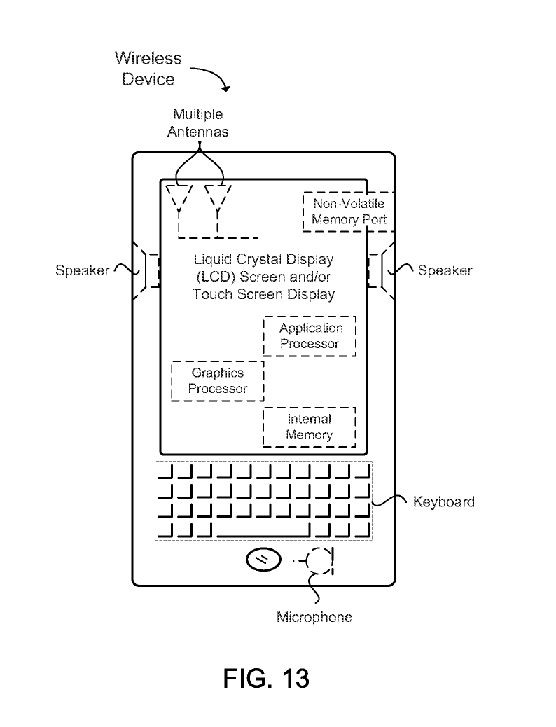

FIG. 13 provides an example illustration of a mobile device, such as UE, a mobile station (MS), a mobile wireless device, a mobile communication device, a tablet, a handset, or other type of mobile wireless device. The mobile device can include one or more antennas configured to communicate with a base station (BS), an eNodeB, or other type of wireless wide area network (WWAN) access point. While two antennas are shown, the mobile device may have between one and four or more antennas. The mobile device can be configured to communicate using at least one wireless communication standard including Third Generation Partnership Project Long Term Evolution (3GPP LTE), Worldwide interoperability for Microwave Access (WiMAX), High Speed Packet Access (HSPA), Bluetooth, WiFi, or other wireless standards. The mobile device can communicate using separate antennas for each wireless communication standard or shared antennas for multiple wireless communication standards. The mobile device can communicate in a wireless local area network (WLAN), a wireless personal area network (WPAN), and/or a wireless wide area network (WWAN).

FIG. 13 also provides an illustration of a microphone and one or more speakers that can be used for audio input and output from the mobile device. The display screen may be a liquid crystal display (LCD) screen, or other type of display screen such as an organic light emitting diode (OLED) display. The display screen can be configured as a touch screen. The touch screen may use capacitive, resistive, or another type of touch screen technology. An application processor and a graphics processor can be coupled to internal memory to provide processing and display capabilities. A non-volatile memory port can also be used to provide data input/output options to a user. The non-volatile memory port may also be used to expand the memory capabilities of the mobile device. A keyboard may be integrated with the mobile device or wirelessly connected to the mobile device to provide additional user input. A virtual keyboard may also be provided using the touch screen.

It should be understood that many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable Form and organized within any suitable type of data structure. The operational data may be collected as a single data set, or may be distributed over different locations including over different storage devices, and may exist, at least partially, merely as electronic signals on a system or network. The modules may be passive or active, including agents operable to perform desired functions.

Various techniques, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as defacto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of materials, fasteners, sizes, lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the cairns set forth below.

What is claimed is:

1. A method for detecting uplink control information on a component carrier configured as a serving cell, comprising:
receiving, at an evolved Node B (eNodeB), a message 1 pertaining to a Random Access CHannel (RACH) communication from a User Equipment (UE);
identifying a Cell-Radio Network Temporary Identifier (C-RNTI) pertaining to the UE to receive a Downlink Control Information (DCI) message including resource allocation information for a message 2 associated with the RACH communication; and
sending the DCI message in at least one channel control element in a UE Specific Search Space (USS) within a Physical Downlink Control CHannel (PDCCH) search space of at least one sub-frame transmitted by the eNodeB, wherein the DCI message is configured with a Cyclic Redundancy Check (CRC), wherein the CRC is configured not to produce a CRC error during blind decoding performed by applying the C-RNTI to the DCI message.

2. The method of claim 1, further comprising padding, at the eNodeB, the DCI message to achieve a size that is substantially equal to a standard size corresponding to at least one other predetermined DCI format to reduce a number of blind decodes used to detect the DCI message.

3. The method of claim 2, further comprising first determining that the RACH is a Secondary Serving Cell (SCell) RACH.

4. The method of claim 2, wherein the standard size corresponding to at least one other predetermined DCI format corresponds to a size of at least one of DCI format 0 and DCI format 1A.

5. The method of claim 1, further comprising embedding, at the eNodeB, the DCI message carried in a number of Control Channel Elements (CCEs) corresponding to at least one predetermined CCE aggregation level to reduce a number of blind decodes used to detect the DCI message.

6. The method of claim 5, wherein the set of predefined aggregation levels comprises at least one of a predefined CCE aggregation level of 4, for a PDCCH search space size of 8 CCEs, and a predefined CCE aggregation level of 8, for a PDCCH search space size of 16 CCEs.

7. The method of claim 1, wherein the message 2 is sent on a different serving cell than the message 1 of the RACH communication in accordance with cross-carrier scheduling.

8. The method of claim 7, further comprising forming a Timing Advance Group (TAG) for multiple Secondary Serving Cells (SCells) with a Timing Advance value that is included in the message 2, wherein the multiple SCells in the TAG are associated with a particular geographic location.

9. The method of claim 1, wherein the (USS) within the PDCCH search space is configured for at least one of a Primary Serving Cell (PCell) and a Secondary Serving Cell (SCell).

10. A device for detecting uplink control information on a component carrier configured as a serving cell, comprising:
a detection module operating at an evolved Node B (eNodeB), the detection module configured to detect a message 1 from a Random Access CHannel (RACH) communication from a User Equipment (UE);
an identification module operating at the eNodeB, the identification module configured to identify a Cell-Radio Network Temporary Identifier (C-RNTI), upon detection of the message 1 by the detection module, the C-RNTI corresponding to a UE Specific Search Space (USS) of a serving cell of the UE with a Physical Downlink Control CHannel (PDCCH);
a message generation module operating at the eNodeB, the message generation module configured to embed the C-RNTI in a Cyclic Redundancy Check (CRC) of a Downlink Control Information (DCI) message together with resource allocation information for a message 2 associated with the RACH communication; and
a transmission module operating at the eNodeB, the transmission module configured to send the DCI message generated by the message generation module to the UE over the serving cell of the UE configured to carry the PDCCH.

11. The device of claim 10, further comprising a padding module in communication with the message generation module, the padding module configured to pad the DCI message so that a location of the CRC embedded in the DCI message corresponds with a standard CRC location corresponding to at least one other predetermined DCI format to reduce a number of blind decodes used to detect the DCI message containing the resource allocation information for the message 2.

12. The device of claim 11, wherein the detection module first determines the RACH communication is a Secondary Serving Cell (SCell) RACH communication.

13. The device of claim 12, wherein the standard CRC location corresponds to a standard CRC location for at least one of DCI format 0 and DCI format 1A.

14. The device of claim 10, further comprising a level determination module within the message generation module, the level determination module configured to determine a number of Control Channel Elements (CCEs) in which to embed the DCI message, the number corresponding to a CCE aggregation level.

15. The device of claim 14, wherein the level determination module determines to embed the DCI message in a number of CCEs corresponding to a CCE aggregation level at least one of 4 and 8.

16. The device of claim 14, wherein the level determination module determines to embed the DCI message in a number of CCEs based on channel information relevant to the PDCCH.

17. The device of claim 10, wherein the message generation is configured to embed a Timing Advance (TA) in the message 2, the TA configured to be a basis for a Timing Advance Group (TAG).

18. A computer program product for detecting uplink control information on a component carrier configured as a serving cell, comprising a non-transitory computer usable medium having a computer readable program code embodied therein, the computer readable program code adapted to be executed at an evolved Node B (eNodeB) to implement a method for reducing blind decodes, comprising:
detecting a Random Access CHannel (RACH) communication from a User Equipment (UE);
determining a serving cell of the UE with a Physical Downlink Control CHannel (PDCCH) on which to respond to the RACH communication;
identifying a Cell-Radio Network Temporary Identifier (C-RNTI) corresponding to a UE Specific Search Space (USS) of the serving cell with the Physical Downlink Control CHannel (PDCCH);
including the C-RNTI in a Cyclic Redundancy Check (CRC) of a Downlink Control Information (DCI) message including resource allocation information for a message 2 associated with the RACH communication; and
sending the DCI message to the UE over the serving cell.

19. The computer program product of claim 18, further comprising padding, at the eNodeB, the DCI message to achieve a size for the DCI message that is substantially equal to a standard size corresponding to at least one other predetermined DCI format such that the CRC of the DCI message and a CRC location of the at least one other predetermined DCI format are substantially aligned to reduce a number of blind decodes used to detect the DCI message including location information for the message 2.

20. The computer program product of claim 19, further comprising determining first that the RACH communication is a Secondary Serving Cell (SCell) RACH communication pertaining to a cross-carrier scheduling communication.

21 .The computer program product of claim 18, further comprising embedding, at the eNodeB, the DCI message in a number of Control Channel Elements (CCEs) corresponding to at least one predetermined CCE aggregation level of 8 and 4 to reduce a number of blind decodes used to detect the DCI message.

22. The computer program product of claim 21, further comprising determining the CCE aggregation level for the DCI message on the basis of a measurement of channel information for the PDCCH.

23. The computer program product of claim 18, further comprising forming a Timing Advance Group (TAG) for multiple Secondary Serving Cells (SCells) with a Timing Advance embedded in the message 2, wherein the multiple SCells in the TAG are associated with a particular geographic location.

24. A method for detecting uplink control information, comprising:
initiating, by a User Equipment (UE), a Random Access CHannel (RACH) communication with an evolved Node B (eNodeB) by sending a RACH message 1 to the eNodeB;
receiving, at the UE, at least one sub-frame transmitted from the eNodeB with, among multiple control channel candidates, a target control channel candidate carrying a Downlink Control Information (DCI) message including resource allocation information for a message 2 associated with the RACH communication, the multiple channel control candidates residing within a UE Specific Search Space (USS) within a Physical Downlink Control CHannel (PDCCH) search space in the at least one sub-frame, the multiple channel control candidates configured with a Cyclic Redundancy Check (CRC);
restricting a series of blind decodes to be performed by the UE to find the DCI message both to the USS and to control channel candidates within the multiple channel control candidates that satisfy at least one predefined format requirement;
performing the series of blind decodes on a reduced set of control channel candidates within the USS that satisfy the at least one predefined format requirement by applying a Cell-Radio Network Temporary Identifier (C-RNTI) to the reduced set of control channel candidates; and
identifying the target control channel candidate within the USS upon an absence of a CRC error code after a blind decode in the series of blind decodes that are performed on the target control channel candidate.

25. The method of claim 24, wherein the RACH message 1 is sent on a serving cell different from a serving cell on which the DCI message is received at the UE.

26. The method of claim 24, wherein the at least one predefined format requirement comprises a Downlink Control Information (DCI) format size corresponding to a standard DCI format size of at least one predetermined DCI format to reduce a number of blind decodes used to detect the DCI message.

27. The method of claim 24, wherein the at least one predefined format requirement comprises at least one Control Channel Element (CCE) aggregation level for a number of CCEs in a given control channel candidate to reduce a number of blind decodes used to detect the DCI message.

28. The method of claim 24, further comprising extracting, at the UE, a Time Advance (TA) from the message 2.

29. The method of claim 28, further comprising forming, at the UE, a Timing Advance Group (TAG) for multiple Secondary Serving Cells (SCells) with the Time Advance (TA).

30. The method of claim 24, wherein the (USS) within the PDCCH search space is configured for at least one of a Primary Serving Cell (PCell) and a Secondary Serving Cell (SCell).
